(19) United States
(12) Patent Application Publication
(10) Pub. No.: US 2019/0170579 A1
(43) Pub. Date: Jun. 6, 2019

(54) MICRO-SCALE WAVEGUIDE SPECTROSCOPE

(71) Applicant: SAMSUNG ELECTRONICS CO., LTD., Suwon-si (KR)

(72) Inventor: Jaesoong LEE, Suwon-si (KR)

(73) Assignee: SAMSUNG ELECTRONICS CO., LTD., Suwon-si (KR)

(21) Appl. No.: 16/043,895

(22) Filed: Jul. 24, 2018

(30) Foreign Application Priority Data
Dec. 1, 2017 (KR) 10-2017-0164335

(51) Int. Cl. G01J 3/28; G01J 3/02; G01J 3/26; G02B 6/02; G02B 6/12

(52) U.S. Cl. CPC G01J 3/2803; G01J 3/0218; G02B 6/12007; G01J 3/26; G02B 6/02304; G01J 3/0291

(57) ABSTRACT

A Micro-scale waveguide spectroscope is provided. The waveguide spectroscope includes a waveguide having a bent region that does not satisfy a total reflection condition, and a light detector arranged on the bent region of the waveguide and configured to detect light emitted from the bent region. The waveguide includes a single layer having a refractive index greater than that of air or includes a core layer and a cladding layer surrounding the core layer. The waveguide has at least a first region having a first radius of curvature and a second region having a second radius of curvature different from the first radius of curvature.

### CROSS-REFERENCE TO RELATED APPLICATION

This application claims the benefit of Korean Patent Application No. 10-2017-0164335, filed on Dec. 1, 2017, in the Korean Intellectual Property Office, the disclosure of which is incorporated herein by reference in its entirety.

### BACKGROUND

### 1. Field

Apparatuses consistent with exemplary embodiments relate to spectroscopes, and more particularly, to micro-scale waveguide spectroscopes.

### 2. Description of the Related Art

A spectroscope is an apparatus that disperses light such that the spectrum of the light may be observed and analyzed with the naked eye. A spectroscope may be used for determining the structure and composition of a material that emits and absorbs light. Spectroscopes include prism spectroscopes that use a prism, grating spectroscopes that use a diffraction grating, and interference spectroscopes that use light interference.

### SUMMARY

One or more exemplary embodiments may provide micro-scale waveguide spectroscopes that have a simple configuration and are configured to increase portability.

According to an aspect of an exemplary embodiment, a micro-scale waveguide spectroscope includes: a waveguide having a bent region that does not satisfy a total internal reflection condition; and a light detector disposed such that light emitted from the waveguide through the bent region is incident thereon, and configured to detect light emitted from the bent region.

The waveguide may include a single layer having a refractive index greater than that of air. The waveguide may include a core layer and a cladding layer surrounding the core layer.

The waveguide may have a provided length and may have a spiral structure having a radius of curvature which gradually decreases from a first end of the waveguide to a second end of the waveguide. The waveguide may have a zigzag form, and bent regions of the zigzag form have gradually increasing radii of curvature.

The core layer may be an air layer, and the cladding layer may be a multi-reflection layer inwardly reflecting light incident thereon from the core layer.

The core layer may be a first material layer having a refractive index greater than air, and the cladding layer may be a second material layer having a refractive index less than that of the first material layer.

The light detectors may each include an optical device performing a photoelectric conversion operation.

The waveguide may have a plurality of bent regions, and radii of curvature of the bending regions may be different from each other.

### BRIEF DESCRIPTION OF THE DRAWINGS

These and/or other exemplary aspects and advantages will become apparent and more readily appreciated from the following description of exemplary embodiments, taken in conjunction with the accompanying drawings in which:

FIG. 1 is a plan view of a micro-scale waveguide spectroscope according to an exemplary embodiment;

FIGS. 2A, 2B, and 2C are graphs of wavelength-intensity with respect to light detected by three light detectors of FIG. 1;

FIG. 3 is a cross-sectional view taken along line 3-3′ of the waveguide of FIG. 1, which illustrates an exemplary configuration of the waveguide;

FIG. 4 is a cross-sectional view taken along line 3-3′ of the waveguide of FIG. 1, which illustrates another exemplary configuration of the waveguide;

FIG. 5 is a plan view of a micro-scale waveguide spectroscope according to another exemplary embodiment;

FIG. 6 shows a configuration of a micro-scale waveguide spectroscope according to another exemplary embodiment; and

FIG. 7 is a magnified view of a first region A1 of FIG. 6.

### DETAILED DESCRIPTION

Micro-scale waveguide spectroscopes according to exemplary embodiments will now be described in detail with reference to the accompanying drawings. In the drawings, thicknesses of layers or regions may be exaggerated for clarity of specification.

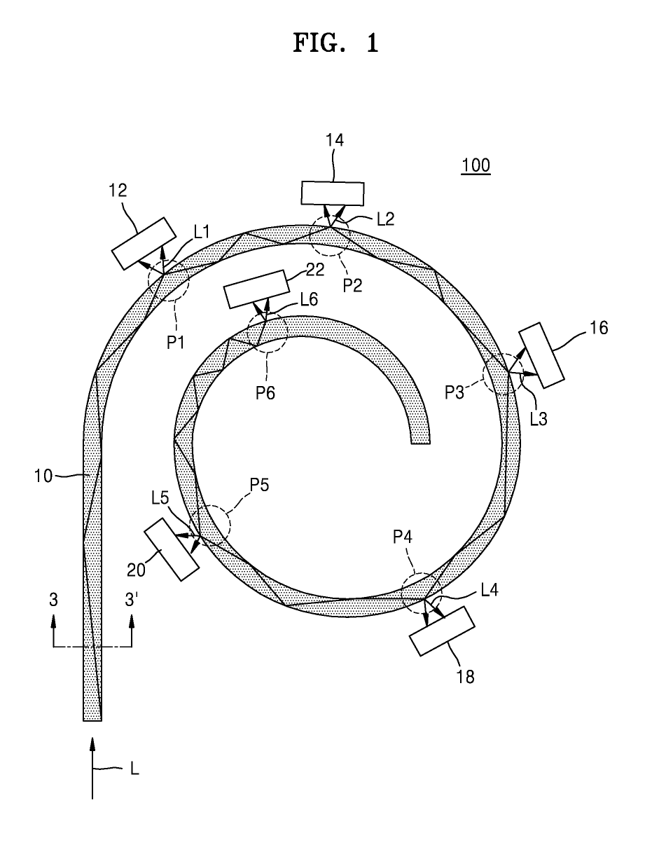

FIG. 1 shows a micro-scale waveguide spectroscope (hereinafter, a first waveguide spectroscope) 100 according to an exemplary embodiment.

Referring to FIG. 1, the first waveguide spectroscope 100 includes a waveguide 10 and a plurality of light detectors 12, 14, 16, 18, 20, and 22. The waveguide 10 is substantially in the shape of an elongated line having a certain length, and is formed into a spiral structure in which a diameter of the spiral is gradually reduced, proceeding from a first end of the waveguide 10 to a second end of the waveguide 10. For convenience, six light detectors 12, 14, 16, 18, 20, and 22 are depicted. However, the number of light detectors may be more than six or less than six according to a wavelength region or band of light to be detected. The light detectors 12, 14, 16, 18, 20, and 22 may be arranged along the waveguide 10.

Light L entering the waveguide 10 progresses along the waveguide 10 through internal total reflection. The waveguide 10 has a structure in which some portions of the waveguide 10 satisfy the total reflection condition but some other portions of the waveguide 10 do not satisfy the total reflection condition. That is, the waveguide 10 includes some sections that satisfy the total reflection condition and first through sixth regions P1 through P6 that do not satisfy the total reflection condition. The first through sixth regions P1 through P6 that do not satisfy the total reflection condition are arranged between the sections that satisfy the total reflection condition. The first through sixth regions P1 through P6 respectively correspond to the locations of the light detectors 12, 14, 16, 18, 20, and 22. In the first through sixth regions P1 through P6 that do not satisfy the total reflection condition in the waveguide 10, lights L1 through L6 are discharged to the outside of the waveguide 10. The spectra of the light L1 through L6 that is discharged to the outside of the waveguide 10, respectively through the first through sixth regions P1 through P6, may be different from each other. Curvatures of the first through sixth regions P1 through P6 may be different from each other. For example, the curvature of the waveguide at the regions P1 through P6 may increase from the first region P1 through the sixth region P6. Also, the distance that the light travels within the waveguide 10, prior to being emitted via one of the regions P1 through P6, may be different from each other. Accordingly, a central wavelength and an intensity of the light emitted from each of the first through sixth regions P1 through P6 may be different. The curvatures of the first through sixth regions P1 through P6 may be controlled in the process of manufacturing the waveguide 10. Accordingly, the curvatures of the regions P1 though P6 may be set in order to control a desired central wavelength of the light emitted from each of the regions P1 through P6. In this way, by setting the curvatures of the first through sixth regions P1 through P6, the central wavelengths of light emitted from the first through sixth regions P1 through P6 may be controlled to be different.

The number of the light detectors 12, 14, 16, 18, 20, and 22 may be equal to the number of the regions P1 through P6 that do not satisfy the total reflection condition. Accordingly, the light detectors 12, 14, 16, 18, 20, and 22 may each correspond to one of the regions P1 through P6. There may be a one-to-one relationship between the regions P1 through P6 and the light detectors 12, 14, 16, 18, 20, and 22. The light detectors 12, 14, 16, 18, 20, and 22 may each be a device that performs a photoelectric conversion operation. For example, the devices may be photo diodes.

Since the curvatures of the first through sixth regions P1 through P6 are set to be different in the process of manufacturing the waveguide 10, light of a specific wavelength is emitted from each of the first through sixth regions P1 through P6 of the waveguide 10. Accordingly, the components and intensity of a wavelength of the light L incident to the waveguide 10, that is, the overall spectrum of the incident light L, may be obtained by detecting and analyzing the light emitted through the first through sixth regions P1 through P6.

As discussed above, the curvatures of the first through sixth regions P1 through P6 are set in the process of manufacturing the waveguide 10 so that light of a specific wavelength is emitted from each of the first through sixth regions P1 through P6. However, in addition to light of the specific wavelength, the light emitted through each of the first through sixth regions P1 through P6 of the waveguide 10 may also include some light of wavelengths adjacent to the specific wavelength.

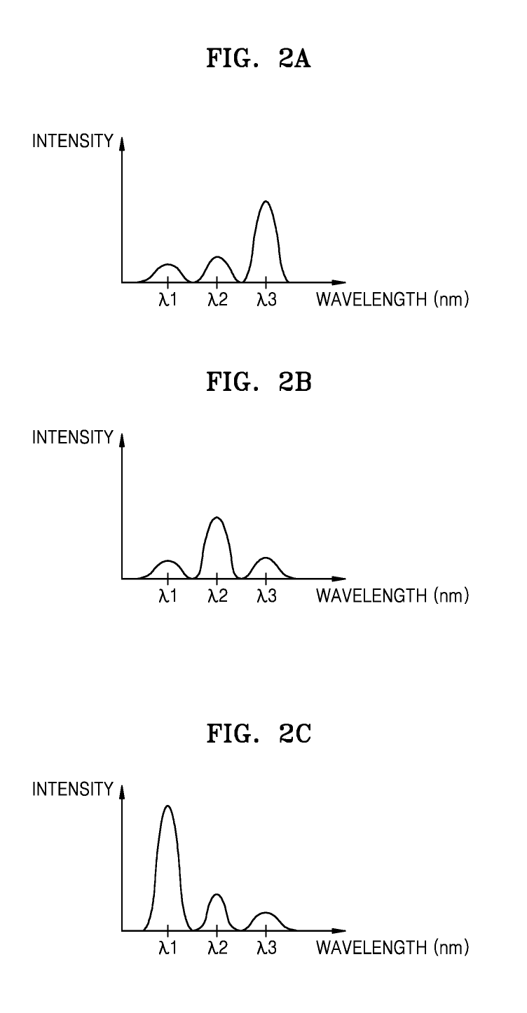

For convenience of explanation, in the following description with respect to FIGS. 2A through 2C, it is assumed that the waveguide 10 includes light leaking regions P1, P3, and P5, and that light detectors 12, 16, and 20 are respectively at the first, third, and fifth regions P1, P3, and P5.

FIG. 2A shows the wavelength-intensity of light measured by the first light detector 12 with respect to light emitted through the first region P1. FIG. 2B shows the wavelength-intensity of light measured by the third light detector 16 with respect to light emitted through the third region P3. FIG. 2C shows the wavelength-intensity of light measured by the fifth light detector 20 with respect to light emitted through the fifth region P5.

Referring to FIG. 2A, light emitted through the first light leaking region P1 includes light having a third wavelength λ3 as a central wavelength, and in addition to the light having the third wavelength λ3, also includes light having first and second wavelengths λ1 and λ2 which have intensities less than that of the third wavelength λ3.

Referring to FIG. 2B, light emitted through the third light leaking region P3 includes light having a second wavelength λ2, as a central wavelength, together with light having first and third wavelengths λ1 and λ3, which have intensities less than that of the second wavelength λ2.

Referring to FIG. 2C, light emitted through the fifth light leaking region P5 includes light having a first wavelength λ1, as a central wavelength, together with light having second and third wavelengths λ2 and λ3, which have intensities less than that of the first wavelength λ1.

The overall spectrum of light L incident into the waveguide 10 may be obtained based on information regarding the light emitted through the first, third, and fifth regions P1, P3, and P5.

The light L incident into the waveguide 10 may include specific information. For example, the light L may be light emitted from a specific sample, or light that has passed through a specific part of an object and includes biological information with respect to the object.

Accordingly, when the overall spectrum of the light L is known, information with respect to the specific sample or biological information with respect to the object may be obtained from the light L.

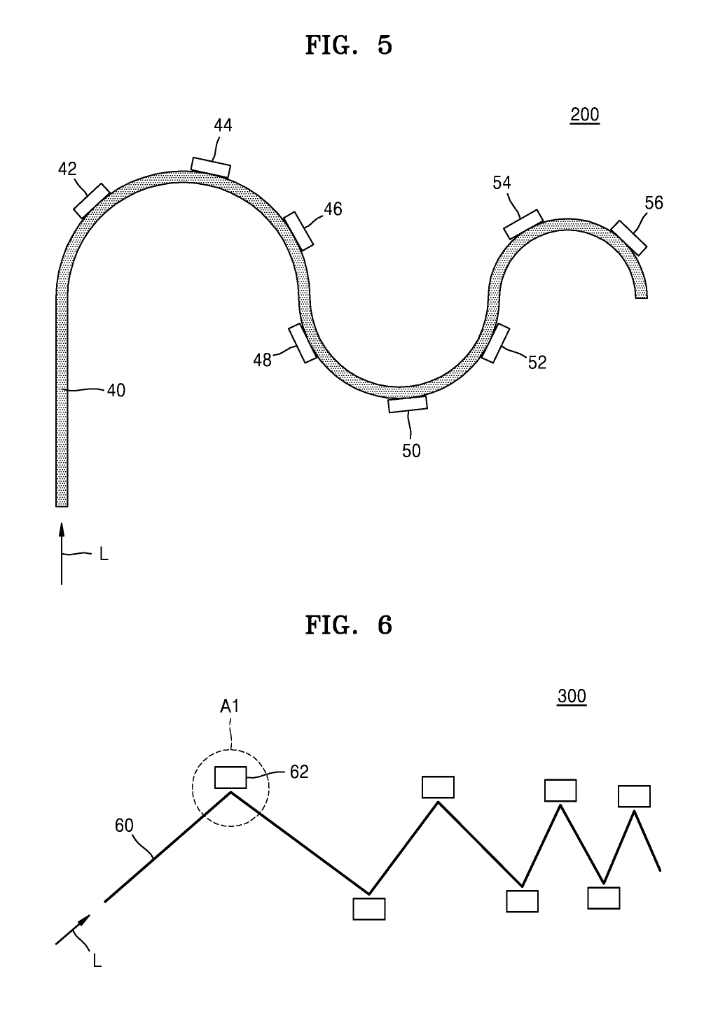

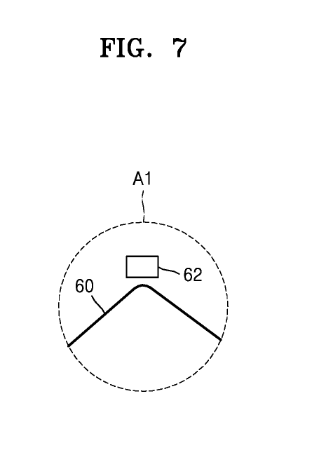

The first waveguide spectroscope 100 described above and second and third waveguide spectroscopes 200 and 300 of FIGS. 5 and 6 are micro-scale waveguide spectroscopes. For example, the first waveguide spectroscope 100 may have a size of approximately 100 μm or a few hundreds of μm, but is not limited thereto.

Since the first through third waveguide spectroscopes 100, 200, and 300 are micro-scale waveguide spectroscopes, the first through third waveguide spectroscopes 100, 200, and 300 may be miniaturized for use on a chip. Accordingly, the first through third waveguide spectroscopes 100, 200, and 300 may be used as portable spectroscopes or spectrum analyzers, and thus, the approach to a sample is easy and an analyzing result may be readily and rapidly obtained.

The upper limit of the micro scale of the first waveguide spectroscope 100 may be determined as follows. When the size of the first waveguide spectroscope 100 is increased while the form thereof is maintained, the light leaking from one or more of the first through sixth regions P1 through P6 may stop at a certain point. Thus, this point may be regarded as the upper limit of an increase in the size of the first waveguide spectroscope 100. This description may also be applied to the second and third first waveguide spectroscopes 200 and 300.

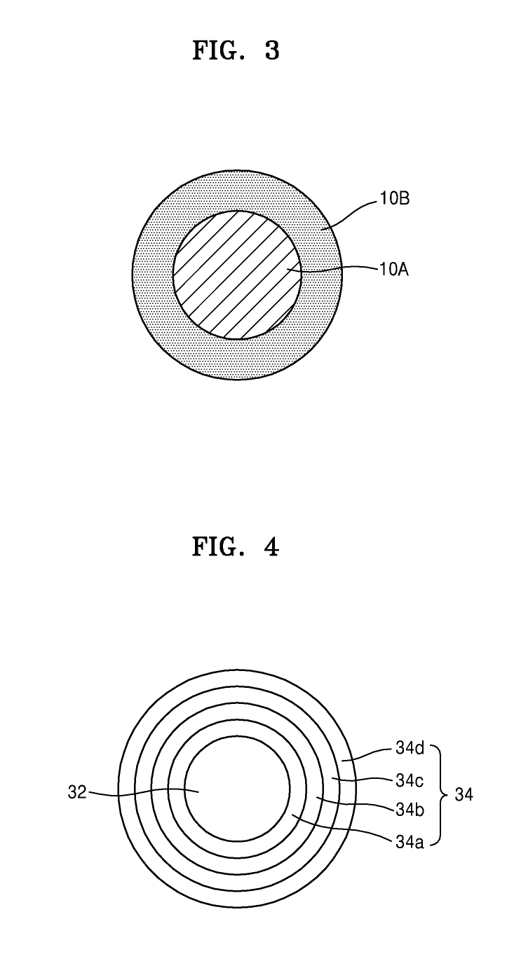

The waveguide 10 may have a configuration including a single material layer having a refractive index greater than that of air. However, the configuration of the waveguide 10 is not limited thereto, and may be any of various types. FIGS. 3 and 4 show various examples of configurations of the waveguide 10.

FIG. 3 is a cross-sectional view taken along line 3-3′ of the waveguide 10 of FIG. 1.

Referring to FIG. 3, the waveguide 10 includes a core layer 10A and a cladding layer 10B that surrounds the core layer 10A. The cladding layer 10B has a refractive index less than that of the core layer 10A.

FIG. 4 is a cross-sectional view taken along line 3-3′ of the waveguide 10 of FIG. 1 as another example of the waveguide 10.

Referring to FIG. 4, the waveguide 10 includes a core layer 32 and a multi-reflection layer 34 that surrounds the core layer 32. The multi-reflection layer 34 may be a Distributed Bragg reflector (DBR) layer. The core layer 32 may be an air layer. The multi-reflection layer 34 may have a refractive index greater than that of air. For convenience, it is depicted that the multi-reflection layer 34 includes first through fourth material layers 34a through 34d. However, the multi-reflection layer 34 may include more than or less than four material layers. In the multi-reflection layer 34, the refractive index may be increased from the first material layer 34a towards the fourth material layer 34d, but the present exemplary embodiment is not limited thereto. That is, so long as light progressing towards the multi-reflection layer 34 from the core layer 32 can be reflected toward the core layer 32, the multi-reflection layer 34 may have any of various refractive index distributions.

FIG. 5 is a plan view of a micro-scale waveguide spectroscope (the second waveguide spectroscope) 200 according to another exemplary embodiment.

Referring to FIG. 5, the second waveguide spectroscope 200 includes a waveguide 40 and a plurality of light detectors 42, 44, 46, 48, 50, 52, 54, and 56. The number of the light detectors 42, 44, 46, 48, 50, 52, 54, and 56 may be increased or reduced. The waveguide 40 may have a zigzag form. The waveguide 40 may have a wave form spreading in a direction. The radius of curvature of the wave may be gradually reduced towards a right side (i.e. from a first end of the waveguide 40 to a second end of the waveguide 40), and thus, the curvature of the waveguide 40 at each of the light detectors 42, 44, 46, 48, 50, 52, 54, and 56 may differ. Portions of the waveguide 40 corresponding to the light detectors 42, 44, 46, 48, 50, 52, 54, and 56 are regions that do not satisfy the total reflection condition, that is, regions from which light leaks to the outside of the waveguide 40. A cross-section of the waveguide 40 may be the same as one of the cross-sections shown in FIGS. 3 and 4. The light detectors 42, 44, 46, 48, 50, 52, 54, and 56 may each be a device performing a photoelectric conversion operation. For example, the devices may be photodiodes.

FIG. 6 is a plan view of a micro-scale waveguide spectroscope (the third waveguide spectroscope) 300 according to another exemplary embodiment. The third waveguide spectroscope 300 is a modified version of the second waveguide spectroscope 200 of FIG. 5.

Referring to FIG. 6, the third waveguide spectroscope 300 includes a waveguide 60 having a zigzag form progressing in a right direction and a plurality of light detectors 62 each arranged at bending regions of the waveguide 60. Portions of the waveguide 60 between the light detectors 62 of the waveguide 60 may be straight lines. A configuration of the waveguide 60 may be the same as that of the waveguide 10 of the first waveguide spectroscope 100 of FIG. 1. The light detectors 62 may also be the same as the light detectors 12, 14, 16, 18, 20, and 22 of the first waveguide spectroscope 100.

FIG. 7 shows a magnified view of the first region A1 of FIG. 6.

Referring to FIG. 7, the bending portion of the waveguide 60 has a curvature breaking a total reflection condition. Accordingly, total internal reflection does not occur at the bending portion. The light detector 62 is positioned to correspond to the bending portion of the waveguide 60.

With reference to FIG. 7, the bending regions of the waveguide 60 of the third waveguide spectroscope 300 of FIG. 6 have different curvatures, and thus, it may be seen that central wavelengths of lights emitted from the bending regions are also different from each other.

While one or more exemplary embodiments have been described with reference to the figures, it will be understood by those of ordinary skill in the art that various changes in form and details may be made therein without departing from the spirit and scope as defined by the following claims.

What is claimed is:

1. A micro-scale waveguide spectroscope comprising:
a waveguide comprising a bent region that does not satisfy a total internal reflection condition; and
a light detector configured to detect light emitted from the bent region.

2. The micro-scale waveguide spectroscope of claim 1, wherein the waveguide comprises a single layer having a refractive index greater than a refractive index of air.

3. The micro-scale waveguide spectroscope of claim 1, wherein the waveguide comprises:
a core layer; and
a cladding layer surrounding the core layer.

4. The micro-scale waveguide spectroscope of claim 1, wherein the waveguide has a spiral structure in which a radius of curvature of the waveguide gradually decreases from a first end of the waveguide to a second end of the waveguide.

5. The micro-scale waveguide spectroscope of claim 1, wherein the waveguide comprises a plurality of bent regions, wherein a radius of curvature of the plurality of bent regions gradually decreases from a first end of the waveguide to a second end of the waveguide.

6. The micro-scale waveguide spectroscope of claim 3, wherein the core layer is an air layer, and the cladding layer is a multi-reflection layer which inwardly reflects light incident thereon from the core layer.

7. The micro-scale waveguide spectroscope of claim 3, wherein
the core layer is a first material layer having a refractive index greater than a refractive index of air, and
the cladding layer is a second material layer having a refractive index less than the refractive index of the first material layer.

8. The micro-scale waveguide spectroscope of claim 1, wherein the light detector comprises an optical device configured to perform photoelectric conversion.

9. The micro-scale waveguide spectroscope of claim 1, wherein the waveguide comprises a plurality of bent regions, and a radius of curvature of each of the plurality of bent regions is different from a radius of curvature of each other of the plurality of bent regions.

10. A micro-scale waveguide spectroscope comprising:
a waveguide comprising a first curved region having a first radius of curvature and a second curved region having a second radius of curvature, different from the first radius of curvature; wherein the first curved region and the second curved region do not satisfy a total internal reflection condition of the waveguide; and
a first light detector disposed such that light emitted from the waveguide through the first curved region is incident thereon, and a second light detector disposed such that light emitted from the waveguide through the second curved region is incident thereon.
